(19) United States
(12) Patent Application Publication
(10) Pub. No.: US 2006/0070813 A1
(43) Pub. Date: Apr. 6, 2006

(54) Spring powered engine

(76) Inventor: John P. Stavropoulos, Toronto (CA)

Correspondence Address: RICHES, MCKENZIE & HERBERT, LLP, SUITE 1800, 2 BLOOR STREET EAST, TORONTO, ON, M4W 3J5, CA

(21) Appl. No.: 10/954,165

(22) Filed: Oct. 1, 2004

(51) Int. Cl. F03G 1/00

(52) U.S. Cl. 185/40 R

(57) ABSTRACT

A spring powered engine comprising a headgear having a cylindrical outer casing with gear threads positioned on a radial circumference of the outer casing. A rotatable headgear shaft is positioned through the outer casing and a spring coil is dispersed within the outer casing, the spring coil having one end fixed to the headgear shaft and another end fixed to the inner circumference of the headgear casing. A motor is provided to wind the coil spring, and the undercarriage of the coil spring rotates the headgear which, through a series of gears and pulleys, rotates a transmission shaft to power a vehicle.

The present invention relates to an engine powered by a spring which does not require any fossil fuel to function and costs much less to construct than conventional engines.

### BACKGROUND OF THE INVENTION

Known prior art engines require gasoline, diesel, propane, kerosene or similar non-renewable fuels in order to function. Therefore, prior art engines are disadvantageous as they produce smog, air and noise pollution. Component parts such as the engine block with its cylinders, pistons, valves, spark plugs, carburetor, exhaust system, cooling system, gas tank, their attachments and accessories, which are common in conventional engines, are neither used nor required in the engine of the present invention.

### SUMMARY OF THE INVENTION

Accordingly, it is an object of this invention to at least partially overcome the disadvantages of the prior art. The present invention provides an engine powered by a spring that overcomes the disadvantages of the ever increasing amount of smog, air and noise pollution emitted in our environment and the constant depletion of the ozone layer to which fuel burning engines contribute. As such, the present invention is less harmful to the environment thereby solving many of the problems created by known fossil fuel burning engines.

The present invention is also advantageous as it provides a more cost effective engine given the limited availability of non-renewable fuels and the continual increase in fuel prices.

Another object of the present invention is to overcome endurance problems of known engines, and to provide an engine which improves function and life expectancy.

In one aspect, the present invention provides an engine comprising: a headgear having a substantially cylindrical outer casing with gear threads positioned on a radial circumference of the outer casing; a rotatable headgear shaft positioned through the outer casing; a spring coil having a first end and a second end, the spring coil being disposed within the headgear casing, the first end being fixed to the headgear shaft and the second end being fixed to an inner circumference of the headgear casing; a motor coupled to the headgear shaft by a motor belt to rotate the headgear shaft and wind the spring coil; a second gear fixed on a second gear shaft, the second gear rotatably engaging the headgear; a third gear fixed on a third gear shaft, the third gear rotatably engaging the second gear; a first bevel gear fixed on a bevel gear shaft, the first bevel gear being connected to the third gear by a gear belt positioned between a pulley fitted on the third gear shaft and a bevel gear pulley positioned on the bevel gear shaft; and the first bevel gear engaging a transmission bevel gear attached to a transmission shaft, wherein unwinding of the spring coil rotates the headgear, which rotates the second and third gears rotating the first bevel gear to rotate the transmission bevel gear and transmission shaft to propel a vehicle.

### BRIEF DESCRIPTION OF THE DRAWINGS

The invention will become more conceivable to the specialists of today's technology by referring to the attached drawing of this description, which clearly depicts some preferred industrial applications of the invention where:

FIG. 1 shows the perspectively contrived coil spring powered engine.

### DETAILED DESCRIPTION OF THE PREFERRED EMBODIMENTS

Referring to the selecting indicative example of manufactural implementation of the invention, an enumeration is given below to the attached drawings, which show the descriptive depiction, not to scale, but simply in the proportional sizes between them.

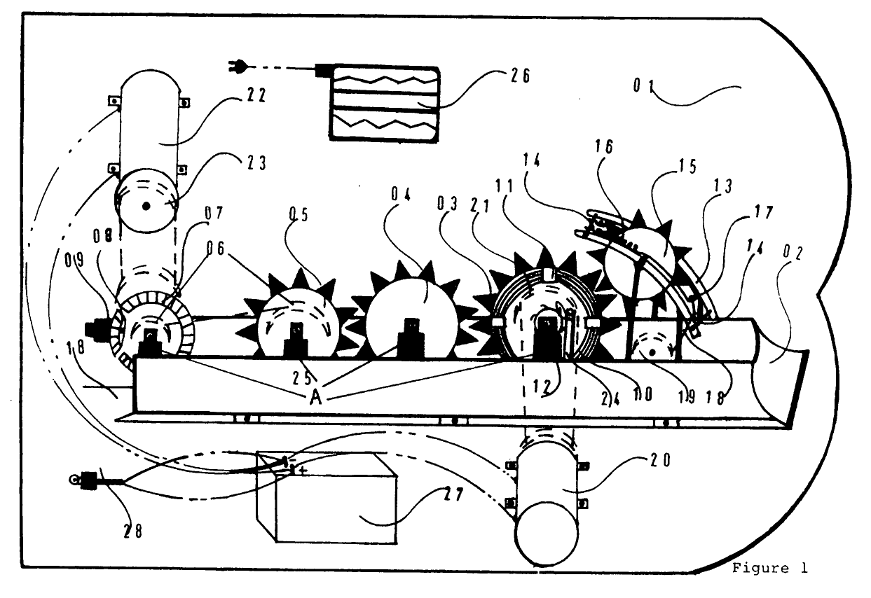

The present invention is now described with reference to FIG. 1.

The engine is supported by a metallic platform approximately one (1) centimeter thick, fitted and welded on the chassis between the front wheels of any ordinary passenger automobile. It is leveled at the appropriate height and has elongated parallel holes in it. The number of holes depends on the size of the engine, but a minimum of three (3) on each side are necessary.

The base is the part on which most component parts are bolted or fitted. It has the same number of elongated holes as the platform 1. The holes are elongated to allow adjustments if necessary.

The headgear is placed towards the front part of a car. It is the largest of all gears used and it is bolted on the base 2.

A connecting gear 4 is bolted on to base 2 and engages headgear 3 and the following gear 5.

The following gear 5 is also bolted on the base 2 and engages gear 4.

A pulley is fitted on the shaft of gear 5 and joins gear 5 with gear 7, because gear 7, is a bevel gear and cannot be joined directly to gear 5.

The bevel gear 7 is connected to gear 5 by the pulley 6 and directly connected to the next gear 8, which is also a bevel gear.

The bevel gear 8 engages bevel gear 7 and firmly fitted on the transmission shaft 9.

The transmission shaft is firmly fitted into bevel gear 8.

A special spring was made, such as those used in a grand father's clock for the experiment on a mid size car. The spring 10 is placed in a metallic casing, which is welded in the centre of headgear 3. The measurements of the spring 10 are as follows: six (6) meters long, six (6) centimeters wide and, one and a half (1½) millimeters thick. The spring 10 is attached to an inner circumference of the metallic casing by suitable mechanical fasteners.

The metallic casing is fitted in the headgear 3 to keep the spring 10 in its place at all times.

A torque is needed to go through gear 3 and the spring 10 to wind it up. The shaft of the torque 12 extends five (5) centimeters on each side in order to fit other parts on it that need to rotate. The spring 10 is attached to the torque 12 by suitable mechanical fasteners.

An acceleration slide consists of two (2) metallic semi circular blades, two (2) millimeters thick, with an opening along side, welded or bolted on base 2 and connected at both ends by two (2) connecting arms 14 which are screwed on to acceleration slide 13.

The connecting arms 14 are one and a half (1½) centimeters thick, threaded at their ends in order to be screwed on the acceleration slide 13 and have two (2) grooves each, on the inside of the acceleration slide 13.

An acceleration gear 15 is the smallest gear used. Its shaft is fitted in the openings of the acceleration slide 13 and on the headgear 3. When the engine is running it turns freely on the headgear 3.

Acceleration springs 16 are placed between the blades of the acceleration slide 13, with the shaft of the acceleration gear 15 inserted in their loops at one end, and the upper connecting arm at the other end. The springs 16 are placed there to regress the acceleration gear 15.

The acceleration handle 17 is hooked on the shaft of the acceleration gear 15, on the opposite side of the acceleration springs 16 and tied to the acceleration cord 18.

The acceleration cord 18 is a metallic cord, tied on the handle 17. The acceleration cord 18 extends from the handle 17, passes under the hollow part of the base 2, it runs under a small pulley 19 first and over another small pulley 19 after, for a smoother pull, and to minimize friction. Finally, the acceleration cord 18 is connected to an acceleration pedal in the cabin of the car.

The two (2) small pulleys 19 mentioned above are placed under base 2 so that the acceleration cord 18 runs on a rather straight line. The pulleys 19 rotate freely.

A D.C. motor is firmly screwed on platform 1 and connected with a belt on pulley 21 which is fitted on the extended shaft of the torque 12.

A pulley on the extended shaft of the torque 12 and connected to the D.C. motor with its belt.

The alternator is screwed on platform 1 and joined by a belt to pulley 23 which is fitted on the shaft of bevel gear 7.

This is a second pulley fitted on the shaft of the same bevel gear 7 but on the back side, connected by its belt on to alternator 22.

A spring holder 24 consists of a small wheel with hooks on it, a hinge with a loop, and a post. The wheel is fitted on the extended part of the shaft of the torque 12 and the hinge with its loop screwed on the metallic post which is fitted on base 2. When the power is cut off, the spring 10 has a tendency to unwind. The holder 24 stops it from doing that and keeps it wound up.

The letter A indicates that the shafts of these gears 3, 4, 5 and 7 are fitted into bearings for a smoother and noiseless performance.

Since there is no cooling system on this engine there is no heating either. Therefore, a small oil filled heater is employed to fulfill this need.

A 12 volt battery is sufficient for the normal operation of a passenger car. The battery is connected to D.C. motor 20, to alternator 22 which charges the battery 27 when the engine is in operation and to power switch 28 which is connected to the steering wheel in the cabin of the automobile.

The power switch is connected to the steering wheel for the driver to turn the power on with the key and start the engine.

All other parts, attachments and accessories as we know them today remain unchanged.

As can be seen on FIG. 1, one embodiment of the present invention operates as outlined below.

When the power switch is turned on, the D.C. motor 20 starts to wind up the spring in the headgear 3 which puts it in motion, gear 3, puts in motion gear 4, gear 4 puts in motion gear 5, gear 5 which is connected by pulley 6 on to gear 7 puts in motion gear 7, bevel gear 7 puts in motion bevel gear 8 and gear 8 which is fitted on to transmission puts in motion the transmission and the vehicle starts moving. All this is done in a split of a second.

Stepping on the accelerator which is connected to acceleration gear 15 puts some pressure on the headgear 3 causing it to turn faster, therefore all turning parts are running faster and the desired speed is acquired.

Stepping on the brakes the car stops and as aforementioned the holder 24 keeps the spring 10 from unwinding.

While the engine is in operation the alternator charges the battery.

It must be estimated that the object of the contrivance is not limited to the above example.

The attainment of the invention is possible to be manufactured in other ways and methods and with other parts, accessories and mechanisms that remain in the scope of the present description.

It must be noted that the present description of the invention was done with reference to only a few indicative examples.

Therefore, any change, alteration or modification to the shape, form, dimensions or attachments, accessories and materials used for the construction and assembly of this engine are considered parts of this invention and are contained in the designs and scope of the present description.

1. An engine comprising:
a headgear having a substantially cylindrical outer casing with gear threads positioned on a radial circumference of the outer casing;
a rotatable headgear shaft positioned through the outer casing;
a spring coil having a first end and a second end, the spring coil being disposed within the headgear casing, the first end being fixed to the headgear shaft and the second end being fixed to an inner circumference of the headgear casing;
a motor coupled to the headgear shaft by a motor belt to rotate the headgear shaft and wind the spring coil;
a second gear fixed on a second gear shaft, the second gear rotatably engaging the headgear;
a third gear fixed on a third gear shaft, the third gear rotatably engaging the second gear;
a first bevel gear fixed on a bevel gear shaft, the first bevel gear being connected to the third gear by a gear belt positioned between a pulley fitted on the third gear shaft and a bevel gear pulley positioned on the bevel gear shaft; and
the first bevel gear engaging a transmission bevel gear attached to a transmission shaft,
wherein unwinding of the spring coil rotates the headgear, which rotates the second and third gears rotating the first bevel gear to rotate the transmission bevel gear and transmission shaft to propel a vehicle.

2. The engine of claim 1, further comprising:
an acceleration gear being fixed on an acceleration gear shaft, the acceleration gear engaging the headgear and freely rotating with a rotation of the headgear,
the acceleration gear having an acceleration handle having at least one free end hooked on the acceleration gear shaft such that the acceleration gear rotates the headgear when a force is applied to the acceleration handle.

3. The engine of claim 1, wherein the motor is powered by a battery, and an alternator is coupled to the first bevel gear to provide electrical charge back to the battery when the bevel gear is rotated.

4. The engine of claim 1, further comprising:
an acceleration gear being fixed on: an acceleration gear shaft, the acceleration gear engaging the headgear and freely rotating with a rotation of the headgear,
the acceleration gear having an acceleration handle having at least one free end hooked on the acceleration gear shaft such that the acceleration gear rotates the headgear when a force is applied to the acceleration handle, and wherein
the motor is powered by a battery, and an alternator is coupled to the first bevel gear to provide electrical charge back to the battery when the bevel gear is rotated.
